(19) United States
(12) Patent Application Publication
(10) Pub. No.: US 2006/0091679 A1
(43) Pub. Date: May 4, 2006

(54) Latch assembly for sliding doors

(76) Inventor: Miao-Hsueh Tsai, Taichung (TW)

Correspondence Address: TSAI MIAO-HSUEH;3F-5, NO.22, LANE 146 DER-FU ROAD, SOUTH AREAS, TAICHUNG CITY, 402, TW

(21) Appl. No.: 10/979,662

(22) Filed: Nov. 4, 2004

(51) Int. Cl. E05C 19/10; E05C 7/00; E05C 9/00

(52) U.S. Cl. 292/24

(57) ABSTRACT

A latch assembly for sliding doors includes a case composed of a base and a cover. A driving knob, two links, two hooks, two adjusting members and two torsion springs are connected between the base and the cover. The driving knob includes a driving surface which is engaged with a straight inside of a through hole of the links. One of the two links is pivotably connected to an adjusting portion of the other link and retaining slot of one of the two hooks. The other link has its positioning portion pivotably connected to the retaining slot 502 of the other hook. By the arrangement, when rotating the driving knob counter clockwise, the two links are pivoted in opposite directions and the two hooks are pivoted in two opposite directions and extend through apertures in the top surface of the base to hook the keeper structure in the jamb or the fixed door.

### FIELD OF THE INVENTION

The present invention relates to a latch assembly with two hooks which are simultaneously pivoted in opposite directions by a driving mechanism.

### BACKGROUND OF THE INVENTION

A conventional patio sliding door generally includes a latch assembly connected to the lock face thereof and including a hook which is operated by a control member so as to be pivoted and extended through the lock face to hook on a keeper structure in a jamb of a fixed door. Before installation, the assemblers have to identify the direction that the sliding door is to be used so that the latch assembly can be functioned as desired in the correct way. This often takes a lot of time to make a final decision. Once the door is installed in the wrong orientation, the door has to be disengaged from the jamb by unscrewing the screws one by one.

The present invention intends to provide a latch assembly for sliding doors and the latch assembly includes two hooks connected by links, a driving mechanism controls the movement of the two hooks which are pivoted outward in opposite directions simultaneously.

### SUMMARY OF THE INVENTION

The present invention relates to a latch assembly for sliding doors and comprises a case composed of a base and a cover. A driving knob, two links, two hooks, two adjusting members and two torsion springs are connected between the base and the cover. The driving knob includes a driving surface which is engaged with a straight inside of a through hole of the links. One of the two links is pivotably connected to an adjusting portion of the other link and retaining slot of one of the two hooks. The other link has its positioning portion pivotably connected to the retaining slot 502 of the other hook. When rotating the driving knob counter clockwise, the two links are pivoted in opposite directions and the two hooks are pivoted in two opposite directions and extend through apertures in the top surface of the base to hook the keeper structure in the jamb or the fixed door.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the latch assembly of the present invention;

FIG. 2 is a cross sectional view to show the latch assembly of the present invention;

FIG. 3 shows the two hooks are pivoted through the apertures in the base;

FIG. 4 shows the two hooks are hooked to the keeper structure;

FIG. 5 shows that the latch assembly of the present invention is adjusted by rotation the adjusting knobs;

FIG. 6 shows the two hooks are hooked to the keeper structure after the adjusting knobs are operated, and

FIG. 7 shows another embodiment of the latch assembly of the present invention.

### DETAILED DESCRIPTION OF THE PREFERRED EMBODIMENT

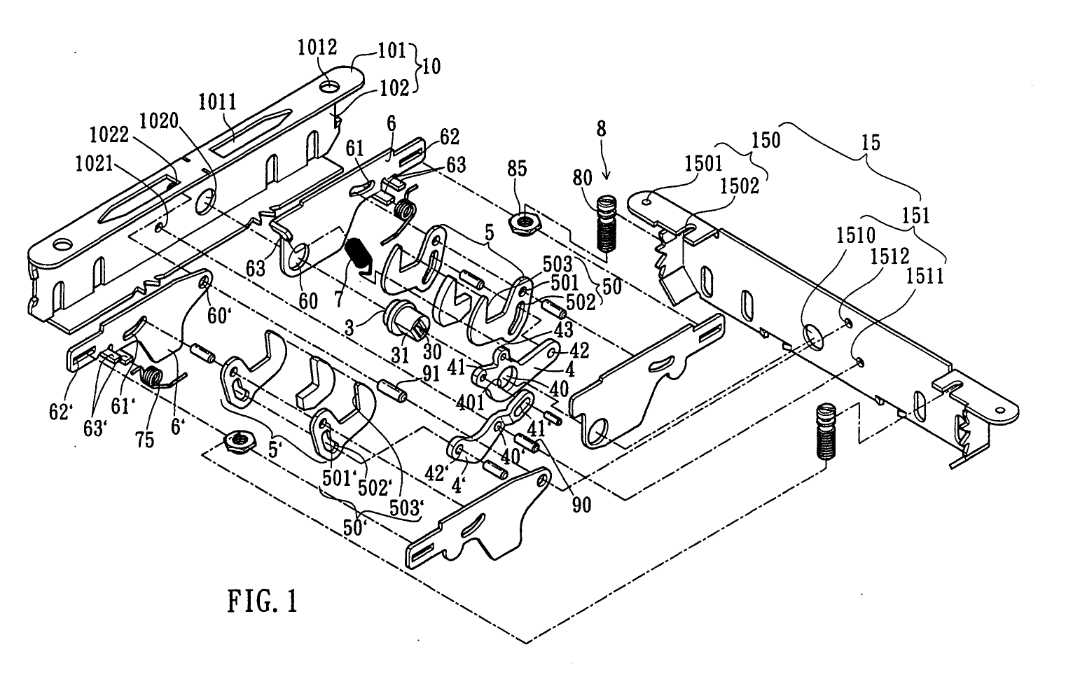

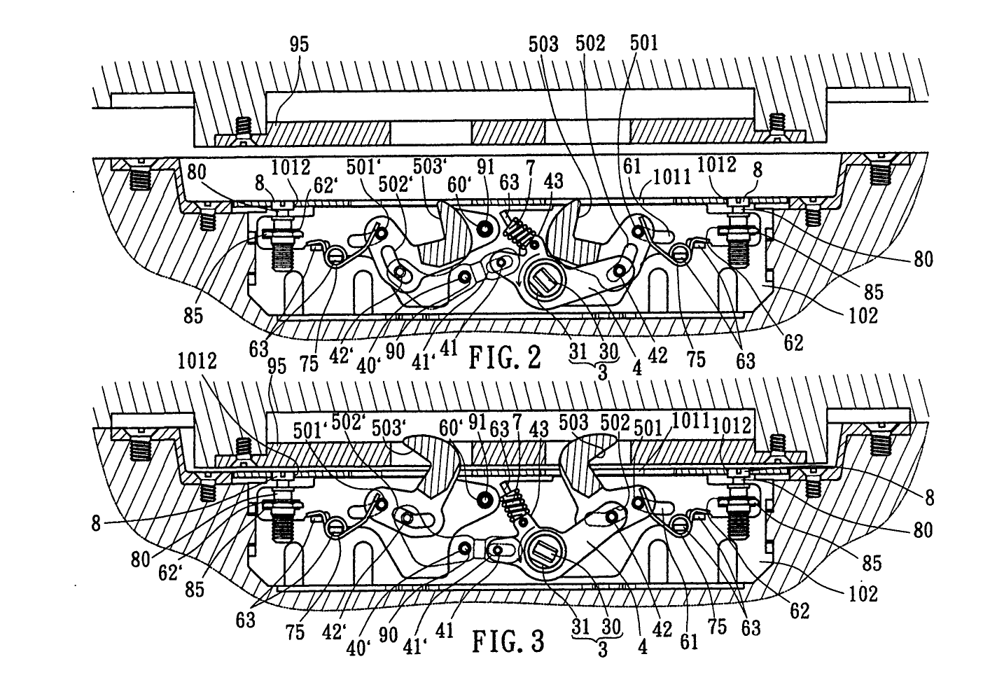

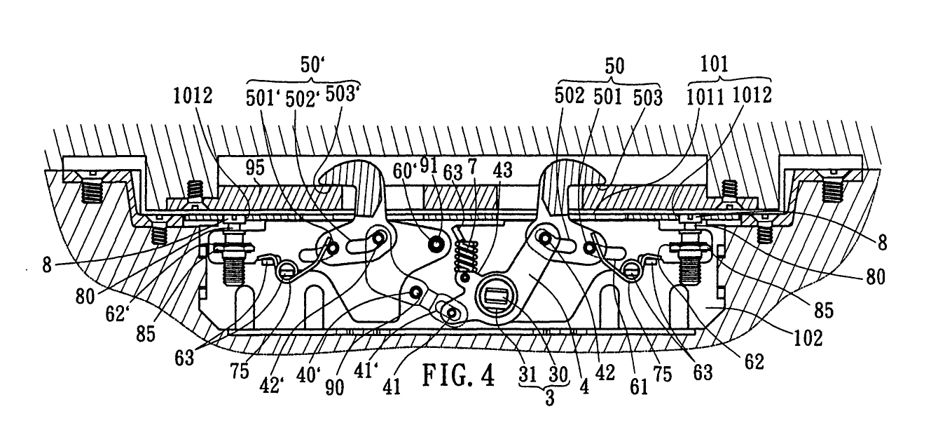

Referring to FIGS. 1 to 4, the latch assembly of the present invention comprises a case 1 composed of a base 10 and a cover 15 which is connected to the base 10 by fixing members 90. The base 10 has a top surface 101 and a side wall 102. The top surface 101 has two apertures 1011 and two retaining holes 1012, and the side wall 102 has a plurality of holes 1020, 1021, 1022. A first end of a driving knob 3 and two respective first ends of the two fixing members 90, 91 respectively extend through the holes 1020, 1021, 1022.

The cover 15 has a plurality of holes 1510, 1511, 1512 defined through a side 151 thereof and being in alignment with the holes 1020, 1021, 1022 in the side wall 102 of the case 10. The cover 15 includes two top surfaces 150 on two ends thereof and each top surface 150 has a positioning hole 1501 and a recess 1502 which is located in alignment with one of the two retaining holes 1012 in the top surface 101 of the bas 10. A second end of the driving knob 3 and two respective second ends of the fixing members 90, 91 are respectively engaged with the holes 1510, 1511, 1512 in the side 151 of the cover 15.

The driving knob 3 has a key hole 30 so that a user may rotate the driving knob 3 by inserting a key in the key hole 30 and rotates the driving knob 3. Two adjusting members 6, 6′ are located between the base 10 and the cover 15 and the first and second ends of the driving knob 3 are engaged with a through hole 60 in the adjusting member 6, the hole 1020 in the side wall 102 of the base 10, a through hole 40 in the link 4, and the hole 1510 in the side 151 of the cover 15. The driving knob 3 further including a driving surface 31 which is engaged with a straight inside 401 in an inner periphery of the through hole 40 of the link 4. The link 4 has two connection portions 41, 42 and a protrusion 43, wherein the two connection portion 41, 42 are located at two sides of the through hole 40 and respectively connected to the hook 5 and the link 4′. The protrusion 43 is connected to an end of a spring 7 so as to compress the spring 7 when the link 4 is pivoted.

The link 4′ has a through hole 40′ through which the fixing member 90 extends which is located between the hole 1021 in the base 10 and the hole 1511 in the cover 15. The link 4′ has an adjusting portion 41′ and a positioning portion 42′ which are located at two sides of the through hole 40′ and respectively connected to the hook 5′ and the link 4.

The hooks 5, 5′ each include a hook member 50/50′ which has a shaft 501/501′, a retaining slot 502/502′ and a hook end 503/503′. The connection portion 42 of the link 4 and the positioning portion 42′ of the link 4′ are pivotably connected with the retaining slots 502, 502′. The hooks 5, 5′ can be a single piece or composed of multiple parts. The connection portions 41, 42 on two sides of the through hole 40 of the link 4 are pivotably connected to the adjusting portion 41′ of the link 4′ and the retaining slot 502 of the hook 5. The positioning portion 42′ of the link 4′ is pivotably connected to the retaining slot 502′ of the hook 5′.

Each of the adjusting members 6, 6′ includes a through hole 60/60′, a guiding slot 61/61′, a limiting slot 62/62′ and a positioning portion 63/63′. The shafts 501, 501′ of the hooks 5, 5′ are located in alignment with guiding slots 61, 61′ of the adjusting members 6, 6′. Two torsion springs 75 are connected to the positioning portions 63, 63′. Two respective first ends of the torsion springs 75 are hooked to the shafts 501, 501′ and push the hooks 5, 5′ within the guiding slot 61, 61′. The limiting slots 62, 62′ receive two nuts 85 therein and two adjusting knobs 8 are respectively movable in the two retaining holes 1012 in the top surface 101 and threadedly connected to the two nuts 85. The adjusting knobs 8 each have a neck portion 80 which is engaged with the recess 1502 corresponding thereto. The two nuts 85 are moved with the adjusting members 6, 6′ when rotating the adjusting knobs 8.

When rotating the driving knob 3 counter clockwise by using the key which is not shown to lock the latch assembly, the rotational force is larger than the force of the spring 7 so that the driving surface 31 drives the straight inside of the link 4 to rotate. The protrusion 43 of the link 4 is moved from the right end to the left end and the link 4 is rotated counter clockwise. The adjusting portion 41 of the link is connected to the adjusting portion 41′ of the link 4′, and the link 4′ is connected between the hole 1021 of the base 10 and the hole 1511 of the cover 15, the connection portion 42 of the link 4 and the connection portion 42′ of the link 4′ are respectively connected to the retaining slots 502, 502 of the two hooks 5, 5′, so that the rotation of the link 4 drives the link 4′ to rotate clockwise about the through hole 40. The hook 5 is then rotated clockwise about the shaft 501. The connection portion 42′ of the link 4′ drives the hook 5′ to rotate counter clockwise about the shaft 501′. The shafts 501 and 501′ may move within the guiding slots 61, 61′ depending the force of the torsion springs 75. The hooks 5, 5′ are stopped when they hook on the keeper board 95 as shown in FIG. 4.

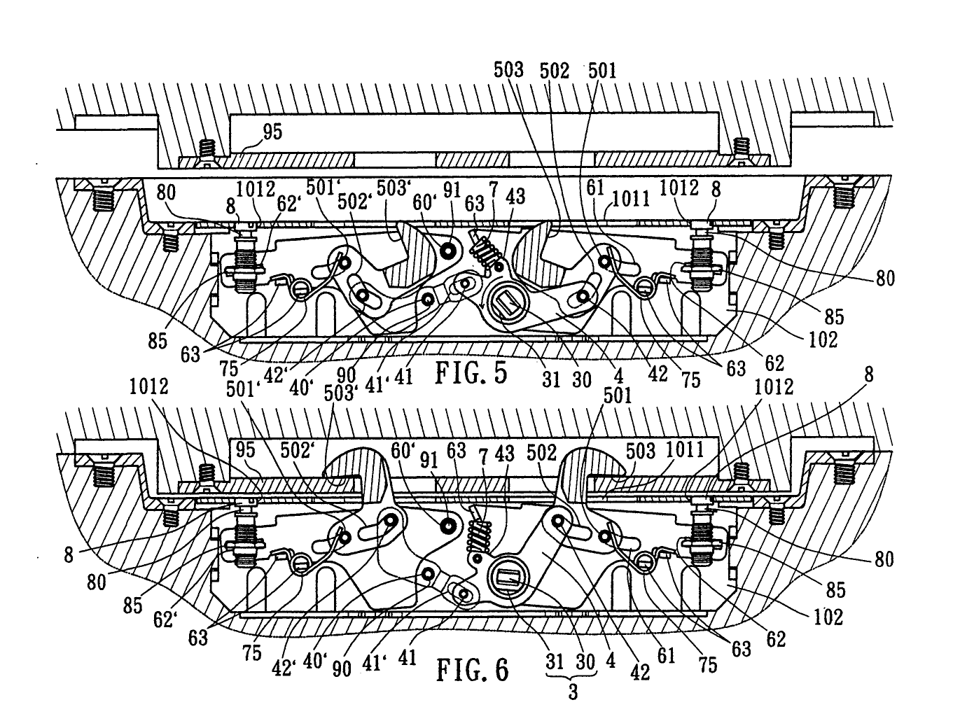

If the keeper board 95 has different thickness, the adjusting knobs 8 are rotated and the nuts 85 are moved downward. Because the nuts 85 are located in the limiting slots 62 so that the adjusting members 6, 6′ are rotated about the through holes 60, 60′. This changes the positions of the hooks 5, 5′ and allows the hook ends 503 to hook the keeper board 95 as shown in FIG. 6. When rotating the driving knob 3 in opposite direction, the two hooks 5, 5′ are hidden in the case 1 and the sliding door can be opened as shown in FIG. 5.

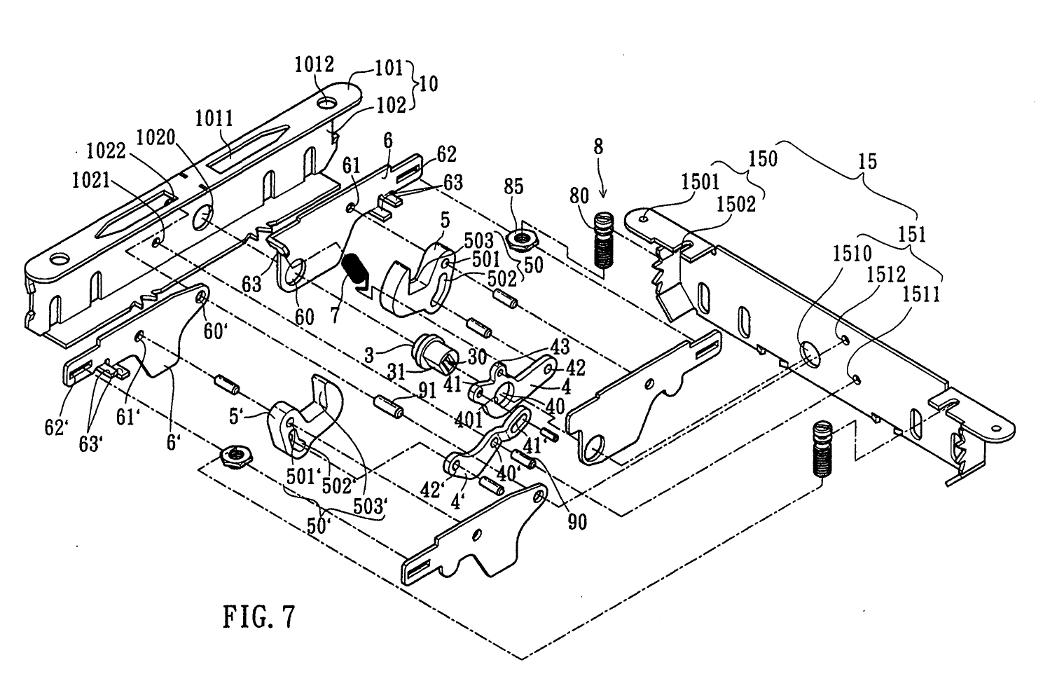

FIG. 7 shows that the guiding slots 61, 61′ can be holes and the hooks 5, 5′ can be made by one piece. The torsion springs 75 on the positioning portions 63, 63′ of the adjusting members 6, 6′ can be omitted.

While we have shown and described the embodiment in accordance with the present invention, it should be clear to those skilled in the art that further embodiments may be made without departing from the scope of the present invention.

What is claimed is:

1. A latch assembly comprising:
a case (1) composed of a base (10) and a cover (15) which is connected to the base (10) by fixing members (90), the base (10) having a top surface (101) and a side wall (102), the top surface (101) having two apertures (1011) and two retaining holes (1012), the side wall (102) having a plurality of holes (1020, 1021, 1022), a first end of a driving knob (3) and two respective first ends of the two fixing members (90, 91) respectively extending through the holes (1020, 1021, 1022);
the cover (15) having a plurality of holes (1510, 1511, 1512) defined through a side (151) thereof and being in alignment with the holes (1020, 1021, 1022) in the side wall (102) of the case (10), a second end of the driving knob (3) and two respective second ends of the fixing members (90, 91) respectively engaged with the holes (1510, 1511, 1512) in the side (151) of the cover (15);
the driving knob (3) having a key hole (30) and two adjusting members (6, 6′) located between the base (10) and the cover (15), the first and second ends of the driving knob (3) engaged with a through hole (60) in the adjusting member (6), the hole (1020) in the side wall (102) of the base (10), a through hole (40) in the link (4), and the hole (1510) in the side (151) of the cover (15), the driving knob (3) including a driving surface (31) which is engaged with a straight inside (401) in an inner periphery of the through hole (40) of the link (4), the link (4) having two connection portions (41, 42) and a protrusion (43), the two connection portion (41, 42) located at two sides of the through hole (40) and respectively connected to the hook (5) and the link (4′), the protrusion (43) connected to an end of a spring (7) so as to compress the spring (7) when the link (4) is pivoted;
the link (4′) having a through hole (40′) through which the fixing member (90) extends and is located between the hole (1021) in the base (10) and the hole (1511) in the cover (15), the link (4′) having an adjusting portion (41′) and a positioning portion (42′) which are located at two sides of the through hole (40′) and respectively connected to the hook (5′) and the link (4);
the hooks (5, 5′) each including a hook member (50/50′) which has a shaft (501/501′), a retaining slot (502/502′) and a hook end (503/503′), the connection portion (42) of the link (4 and the positioning portion (42′) of the link (4′) pivotably connected with the retaining slots (502, 502′);
the connection portions (41, 42) on two sides of the through hole (40) of the link (4) being pivotably connected to the adjusting portion (41′) of the link (4′) and the retaining slot (502) of the hook (5), the positioning portion (42′) of the link (4′) pivotably connected to the retaining slot (502′) of the hook (5′), when rotating the driving knob (3) counter clockwise, the two links (4, 4′) rotate in opposite directions and the tow hooks (5, 5′) being pivoted in two opposite directions and extending through the apertures (1011) of the bas (10).

2. The assembly as claimed in claim 1, wherein two adjusting knobs (8) are respectively movable in the two retaining holes (1012) in the top surface (101).

3. The assembly as claimed in claim 2, wherein the cover (15) includes two top surfaces (150) on two ends thereof and each top surface (150) has a positioning hole (1501) and a recess (1502) which is located in alignment with one of the two retaining holes (1012) in the top surface (101) of the bas (10), the adjusting knobs (8) each having a neck portion (80) which is engaged with the recess (1502) corresponding thereto.

4. The assembly as claimed in claim 1, wherein the shafts (501, 501′) of the hooks (5, 5′) are located in alignment with guiding slots (61, 61′) of the adjusting members (6, 6′).

5. The assembly as claimed in claim 1, wherein each of the adjusting members (6, 6′) includes a through hole (60/60′), a guiding slot (61/61′), a limiting slot (62/62′) and a positioning portion (63/63′), two torsion springs (75) connected to the positioning portions (63, 63′), two respective first ends of the torsion springs (75) hooked to the shafts (501, 501′) and pushing the hooks (5, 5′) within the guiding slot (61, 61′), the limiting slots (62, 62′) receiving two nuts (85) therein which is moved with the adjusting members (6, 6′) when rotating the adjusting knobs (8).
